(19) United States
(12) Patent Application Publication
(10) Pub. No.: US 2005/0265313 A1
(43) Pub. Date: Dec. 1, 2005

(54) Communication system

(75) Inventor: Miikka Poikselka, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/934,534

(22) Filed: Sep. 7, 2004

(30) Foreign Application Priority Data
May 7, 2004 (GB) 0410270.3

(51) Int. Cl. H04L 12/66

(52) U.S. Cl. 370/352

(57) ABSTRACT

A communication system that includes a group of user equipment in communication over a shared floor. The system also includes a server for managing the shared floor, wherein at least one of the group of user equipment is provided with information from the server identifying the group when the server sends a floor control message.

### FIELD OF THE INVENTION

The present invention relates to a communication system and in particular but not exclusively to a communication system for use in a push-to-talk over cellular communications system.

### BACKGROUND OF THE INVENTION

A communication system can be seen as a facility that enables communication sessions between two or more entities such as user equipment and/or other nodes associated with the communication system. The communication may comprise, for example, communication of voice, data, multimedia and the like. A session may, for example, be a telephone call type session between users, a multi-way conference session, or a communication session between user equipment and an application server (AS) such as a service provider server.

A communication system typically operates in accordance with a given standard or specification which sets out what the various entities associated with the communication system are permitted to do and how that should be achieved. For example, the standard or specification may define if the user, or more precisely, user equipment is provided with a circuit switched service and/or a packet switched service. Communication protocols and/or parameters which shall be used for the connection may also be defined. In other words, a specific set of rules on which the communication can be based is defined to enable communication.

Communication systems providing wireless communication for user equipment is known. An example of a wireless system is the public land mobile network (PLMN). PLMNs are commonly based on cellular technology. In cellular systems, a base transceiver station (BTS) or similar access entity services mobile user equipment (UE) via a wireless interface between these entities. The communication on the wireless interface between the user equipment and elements of the communication network can be based on an appropriate communication protocol. The operation of the base station apparatus and other apparatus required for the communication can be controlled by one or several control entities. The various control entities may be interconnected.

One or more gateway nodes may be provided for connecting the cellular access network to other networks, for example to a public switched telephone network (PSTN) and/or other communication networks such as an IP (Internet Protocol) and/or other packet switched data networks. In such arrangements, the mobile communications network provides an access network enabling a user with wireless user equipment to access external networks, hosts, or services offered by specific service providers.

An example of the type of services that may be offered to a user such as a subscriber to a communication system is the so called multimedia service. Some of the communication systems enabled to offer multimedia services are known as internet protocol multimedia networks. IP multimedia functionalities can be provided by means of an IP multimedia core network subsystem (IMS). The IMS includes various network entities for the provision of multimedia services. IMS services are intended to offer, amongst other services, IP based packet data communication sessions between mobile user equipment.

In a packet data network, a packet data carrier may be established to carry traffic flows over the network. An example of such a packet data carrier is a packet data protocol (PDP) context.

Various types of services are provided by means of different application servers (AS) over IMS. Some of these services may be time critical. An example of a time critical service that may be provided over the IMS is the so-called direct voice communication service. One example of this type of service is the “push-to-talk over cellular” (PoC) service also known as the PTT (push-to-talk service). The direct voice communication services are intended to use the capabilities of the IMS to enable IP connections for user equipment and other parties to the communication, such as other user equipment or entities associated with the network. The service allows users to engage in immediate communication with one or more users.

The principle behind push-to-talk over cellular (PoC) communication systems is one where the capabilities of a walkie-talkie system are implemented within a standard cellular phone. Users simply select the person or groups of persons they wish to talk to from their phone and press the push to talk key on their mobile phone to start talking. The activation may be via a specific button, tangent or any other appropriate key of the keyboard. Similar principals apply with devices having touch sensitive or sound activated user interfaces. While the user speaks, the other user or users may listen. Bi-directional communication may be offered since all parties of the communication session may similarly communicate voice data with the PoC application server. Turns to speak are requested by activating the push to talk button or the like. The response time of connection is almost instantaneous.

Push-to-talk calls are typically half-duplex communications, i.e. while one user speaks the others listen. The turn to speak is granted by pressing the push-to-talk key on a first come first served basis or based on priorities. Push-to-talk calls are usually connected without the recipient answering and typically received through the phone's built in loud speaker.

As this system is integrated within the cellular telecommunication system this provides a coverage area greater than that provided using traditional two-way radio systems. The push-to-talk service is implemented using push-to-talk servers in a IP multimedia subsystem (IMS) system. The push to talk service is based on multi-unicasting. Each transmitting handset sends packet data traffic to a dedicated push-to-talk server and in case of a group call, the server then duplicates the traffic to be received by all recipients. No multi-casting is performed either in the GPRS access network or over the radio access network.

The push to talk over cellular telecommunication system such as described within the push to talk over cellular draft provisions such as the “OMA Push to talk over Cellular (PoC)-Architecture”

A group of user equipment can be created in various ways. The Internet Engineering Task Force (IETF) defines one such system using session initiation protocol (SIP) or Conference Policy Control Protocol (CPCP). These systems could be utilised within the push-to-talk system. Voice and data control traffic is carried through a real time protocol (RTP) streaming bearer. The PoC system uses transport protocols based on those described in IETF RFC 3550. The RTP protocol describes the architecture of the data packets and the syntax of the data stored within the packets passing the voice and data information from user to user.

In the PoC system, a user needs to know the address of the group, for example the Uniform Resource Identifier (URI) of the group, in order to subscribe to the participant information. The subscription to the participant information for example allows the user to receive notifications about changes in the current membership of this conference (in other words the current members of the group), the partition status of the users in the conference, and the sidebars in the conference. Additionally, if a user disconnects from the group the user needs to know the address of the group (e.g. Uniform Resource Identifier (URI) in order rejoin the group.

It is the aim of embodiment of the present invention to address or at least mitigate the problems described above.

### SUMMARY OF THE INVENTION

There is provided according to the invention a communication system comprising: a group of user equipment in communication over a shared floor; and a server for managing the shared floor; wherein at least one of said group of user equipment is provided with information from the server identifying said group when the server sends a floor control message.

The information may comprise at least one of a URI of the group and a display name of the group.

One of said group may be arranged to initiate a connection with at least one other of said group via said server using a first protocol.

The first protocol may be a session initiation protocol (SIP).

One of said group of user equipment may be arranged to communicate with said second user equipment via said server using a second protocol.

The second protocol may be a real time control protocol (RTCP).

The at least one of said group of user equipment provided with information identifying said group may be arranged to receive said information in a message using said second protocol.

The at least one of said group of user equipment provided with information identifying said group is preferably arranged to use said information to subscribe to group participation information or rejoin said group.

The information is preferably provided to said at least one of said group in a real time control protocol (RTCP) message.

The communications system may comprise a push-to-talk over cellular communications system.

The information is preferably provided to said at least one of said group in a floor control message.

The information may include information about which user equipment has taken the shared floor for communicating with other user equipment of the group.

The floor control message is preferably a ‘floor taken’ message.

The information may be stored within said ‘floor taken’ message as at least part of a source description item.

The information is preferably provided in a message concatenated with information identifying at least one user.

The information may be provided in a field of a message containing a plurality of fields.

The field for said information may contain only said information or said information along with further information.

The server may comprise a push-to-talk over cellular (PoC) server.

According to a second aspect of the invention there is provided a server arranged to operate in a communications system, said communications system further comprising a group of user equipment in communication over a shared floor wherein said server is arranged to manage the shared floor and is further arranged to transmit to at least one of said user equipment information identifying said group when the server sends a floor control message.

According to a third aspect of the invention there is provided user equipment arranged to operate in a communications system over a shared floor, said communications system further comprising a server arranged to manage the shared floor, wherein said user equipment is arranged to receive from said server information identifying said group when the server sends a floor control message.

According to a fourth aspect of the invention there is provided a method of communication, within a communications system comprising a group of user equipment in communication over a shared floor and a server arranged to manage the shared floor, said method comprising the steps of: transmitting from said server to at least one of said group of user equipment information identifying said group when the server sends a floor control message, receiving at said at least one user equipment said information.

The floor control messages using real time control protocol (RTCP) data packet may be enhanced to include the session initiation protocol (SIP) uniform resource indicator (URI) of the group identity and additionally the display name of the group. A user is therefore able to make participation information subscription and rejoin the group session later on.

### BRIEF DESCRIPTION OF THE DRAWINGS

For a better understanding of the present invention and how the same may be carried into effect, reference will now be made by way of example only to the accompanying drawings in which:

FIG. 1 shows a schematic view of a typical push-to-talk communications network incorporating an embodiment of the present invention;

FIG. 2 shows a schematic view of a real time control protocol (RTCP) “floor taken” data packet including a first embodiment of the present invention;

FIG. 3 shows a schematic view of a RTCP “floor taken” data packet incorporating a second embodiment of the present invention; and

FIG. 4 shows a schematic view of a “PRIV” source description data packet incorporating a third embodiment of the present invention.

### DETAILED DESCRIPTION OF EMBODIMENTS OF THE PRESENT INVENTION

Certain embodiments of the present invention will be described by way of example, with reference to the exemplifying architecture of a third generation (3G mobile communication system). However it will be understood that embodiments may be applied to any other suitable forms of communication system.

The third generation partnership project (3GPP) has defined a reference architecture for the third generation (3G) core network which will provide the users of user equipment with access to multimedia services. This core network is divided into three principal domains. These are the circuit switched (CS) domain, the packet switched (PS) domain and the internet protocol multimedia subsystem (IMS) domain.

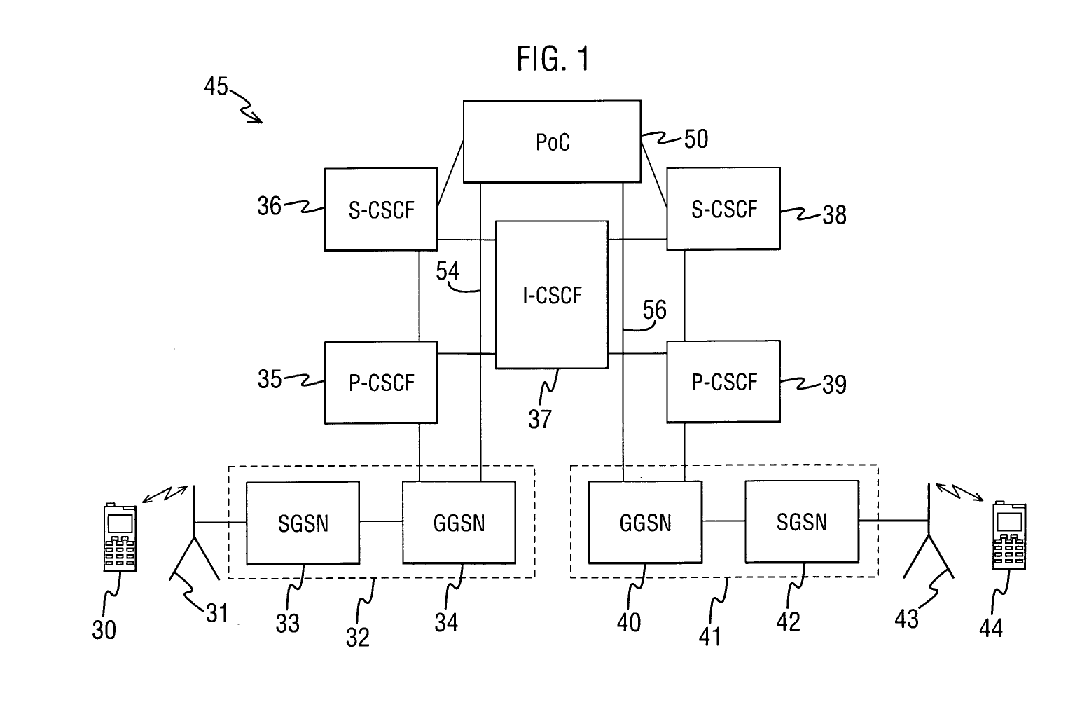

FIG. 1 shows an IP multimedia network 45 for offering IP multimedia services to IP multimedia network subscribers. IP multimedia subsystem (IMS) functionalities may be provided by a core network (CN) subsystem including various entities for the provision of the service. The third generation partnership project (3GPP) has defined the use of the general packet radio service (GPRS) for offering IP connectivity to IMS services. Accordingly, a GPRS based system will be used in the following example of a possible back bone communication network enabling the IMS services.

A mobile communication system such as the 3G cellular system is typically arranged to serve a plurality of mobile user equipment, usually via a wireless interface between the user equipment and base stations of the communication system. The mobile communication system may logically be divided between a radio access network (RAN) and a core network (CN). The core network entities typically include various control entities and gateways for enabling the communication via a number of radio access networks and also for interfacing a single communication system with one or more communication systems such as with other cellular systems and/or fixed line communications systems.

In FIG. 1, the intermediate mobile communication network provides packet switched data transmission in the packet switched domain between a support node and mobile user equipment. Different sub networks are in turn connected to an external data network, for example to a packet switched data network (PSDN) via gateway GPRS support nodes (GGSN) 34, 40. The GPRS services thus allow transmission of packet data between mobile data terminals and/or external data networks. More particularly, the exemplifying general packet radio services operation environment comprising one or more sub network service areas, which are interconnected by GPRS back bone networks 32 and 41. A sub network comprises a number of packet data service nodes (SN). In this embodiment, the service nodes will be referred to as serving GPRS support nodes (SGSN). Each of the SGSNs 33, 42 is connected to at least one mobile communication network, typically to base station systems. Although not shown for clarity reasons, the connection may be provided by way of radio network controllers or other access system controllers such as base station controllers in such a way that packet service can be provided for mobile user equipment via several base stations.

Base stations 31 and 43 are arranged to transmit signals to and receive signals from mobile user equipment 30 and 44 of mobile users i.e. subscribers, via respective wireless interfaces. Correspondingly, each of the mobile user equipment is able to transmit signals to and receive signals from the base stations via the wireless interface. In the simplified representation of FIG. 1, the base stations 31 and 43 belong to respective radio access networks (RAN). In the arrangement shown, each of the user equipment 30 and 44 may access the IMS network 45 via the two access networks associated with the base stations 31 and 43 respectively. It should be appreciated that, although FIG. 1 only shows the base stations of two radio access networks, a typical mobile communication network usually includes a number of radio access networks.

The IMS domain is for ensuring that multimedia services are adequately managed. The IMS domain commonly supports the session initiation protocol (SIP) as developed by the internet engineering task force (IETF). Session initiation protocol (SIP) is an application-layer control protocol for creating, modifying and terminating sessions with one or more participants (end point). SIP was generally developed to allow for the initiation of a session between two or more end points in the Internet by making these end points aware of the session semantics. A user connected to an SIP base communication system may communicate with various entities of the communication system based on standardised SIP messages. User equipment or users that run certain applications on the user equipment are registered with the SIP backbone so that an invitation to a particular session can be correctly delivered to these end points. SIP provides a registration mechanism for devices and users and it applies mechanisms such as location servers and registrars to route the session invitations appropriately. Examples of proper possible sessions that may be provided by SIP signalling include internet multimedia conferences, internet telephone calls and multimedia distribution.

User equipment within the radio access network may communicate with a radio network controller via radio network channels which are typically referred to as radio bearers. Each user equipment may have one or more radio channels open at any one time with the radio network controller. Any appropriate mobile user equipment adapted for internet protocol (IP) communication maybe used to connect to the network. For example, a user may access the cellular network by means of user equipment such as a personal computer, personal data assistant (PDA), mobile station (MS), portable computer, combinations thereof or the like. Embodiments of the present invention are described in the context of mobile stations.

A mobile station is used for tasks such as making and receiving phone calls, for receiving and sending data from and to a network and for experiencing for example multimedia content. A mobile station is typically provided with a processor and memory for accomplishing these tasks. A mobile station may include an antenna for wirelessly receiving and transmitting signals from and to base stations of the mobile communication network. A mobile station may also be provided with a display for displaying images and other graphical information for the user of the mobile user equipment. A speaker may also be provided. The operation of the mobile station may be controlled by means of a suitable user interface such as key pad, voice commands, touch sensitive screen or pad, combinations thereof or the like.

The mobile stations 30 and 44 of FIG. 1 are configured to enable the use of push to talk types of services. An activation function that may be required by a push to talk service can be provided by one of the buttons on the keypad of the mobile station 30 and 44 or by a specific key or button such as the type known from—“walkie-talkie” devices.

It should be appreciated that FIG. 1 only shows two mobile stations for clarity. In practice, a number of mobile stations may be in simultaneous communication with each base station. A mobile station may have several simultaneous sessions, for example a number of SIP sessions and activated PDP contexts. For example, the user may have a phone call and be simultaneously connected to at least one other service.

Overall communication between user equipment in an access entity and the GGSN is provided by a PDP context. Each PDP context provides a communication pathway between a particular user and a GGSN. Once the PDP context is established, it can typically carry multiple flows. Each flow normally represents, for example, a particular service and/or media component of a particular service. The PDP context therefore often represents a logical communication pathway for one or more flows across the network. To implement the PDP context between user equipment and the serving GPRS support node, radio access bearers need to be established which commonly allow for data transfer for the user equipment.

Communication systems have developed such that services may be provided for user equipment by means of various functions of the IM network 45 that are handled by network entities and served by the servers. In the current 3G wireless multimedia network architectures, it is assumed that several different servers are for handling different functions. These include functions such as the call session control functions (CSCF). The call session control functions can be divided into various categories such as a proxy call session control function (P-CSCF) 35, 39, interrogating call session control function (I-CSCF) 37 and serving call session control function (S-CSCF) 36, 38.

The user equipment 30, 44 may connect via the GPRS network to application servers that are generally connected to the IMS. In FIG. 1, such an application server is provided by a push-to-talk-over cellular (PoC) services server 50. In one modification there may be another PoC server for the called party. Thus, it should be appreciated that the PoC server connected to S-CSCF 38 may not be the same as the PoC server connected to the S-CSCF 36.

The mobile user equipment 30 and 44 can be from different IMS networks.

The PoC application server is for providing push-to-talk over cellular (PoC) services over the IMS network 45. The push-to-talk service is an example of the so called direct voice communication service. Users who wish to use the PoC service may need to subscribe to an appropriate PoC server.

The direct voice communication services are intended to use the capabilities of the GPRS back bone and the control functions of the multimedia subsystem for enabling IP connections with the mobile stations 30 and 44. The PoC server may be operated by the operator of the IMS system or a third party service provider.

A user may open the communication link, for example, by pressing a specific activation button on the mobile station 30. While the user of the mobile station 30 speaks, the user of the mobile station 44 listens. The user of the mobile station 44 may then reply in a similar manner. The signalling between the user equipment and the appropriate call session control functions is routed via the GPRS network. The user plane session sets up signalling for the user equipment and is routed via and controlled by the PoC application server 50. In other words, the PoC application server 50 can control both the control plane (for signalling) and the User plane (for user data) of the PoC user. The control plane traffic between the PoC application server and the user equipment may be routed via the IMS 45 whilst the user plane traffic between the user equipment and the PoC server may be routed from the GPRS system to the PoC application server on interfaces 54 and 56.

As discussed earlier the push-to-talk service is based on multi-unicasting. Each transmitting user equipment sends packet data traffic to a dedicated push-to-talk server and in case of a group call, the server then duplicates the traffic to all recipients. In order to control the communications system ‘floor control’ messages can be passed from one user to the rest of the system and vice versa. One type of data communications packet in the user plane is that of informing which user is transmitting or has received permission to use the floor. This information could be a ‘floor taken’ message. This ‘floor taken’ information is received by the user equipment which will receive RTP traffic from the user who has taken control of the floor. These control packets are based on a real time control protocol (RTCP) packet, a subset of the real time protocols (RTP) described earlier.

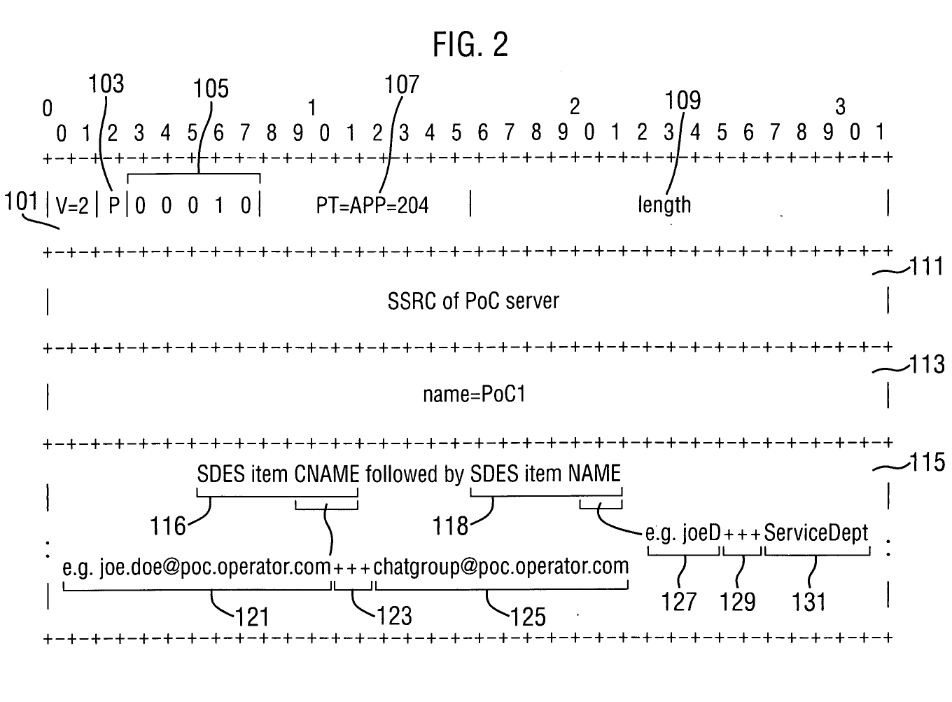

With respect to FIG. 2 a real time control protocol (RTCP) based packet such as that used passing a ‘floor taken’ data packet incorporating a first embodiment of the present invention is shown.

The ‘floor taken’ RTCP packet is transmitted from a PoC Server 50 controlling the session through the network to user equipment 11 and prepares the user equipment to receive RTP packets from the user equipment which has been granted the floor. The ‘floor taken’ RTCP packet indicates that the PoC Server controlling the session has given a permission to speak to a user equipment from the group.

The ‘floor taken’ RTCP packet comprises a datagram 32 bits in width. The first line of the datagram comprises a series of information values, a version indicator (V) 101 (2 bits), a padding bit (P) (1 bit) 103, a source count (5 bits), a payload type (PT) (8 bits) 107, and a length indicator (length) 109.

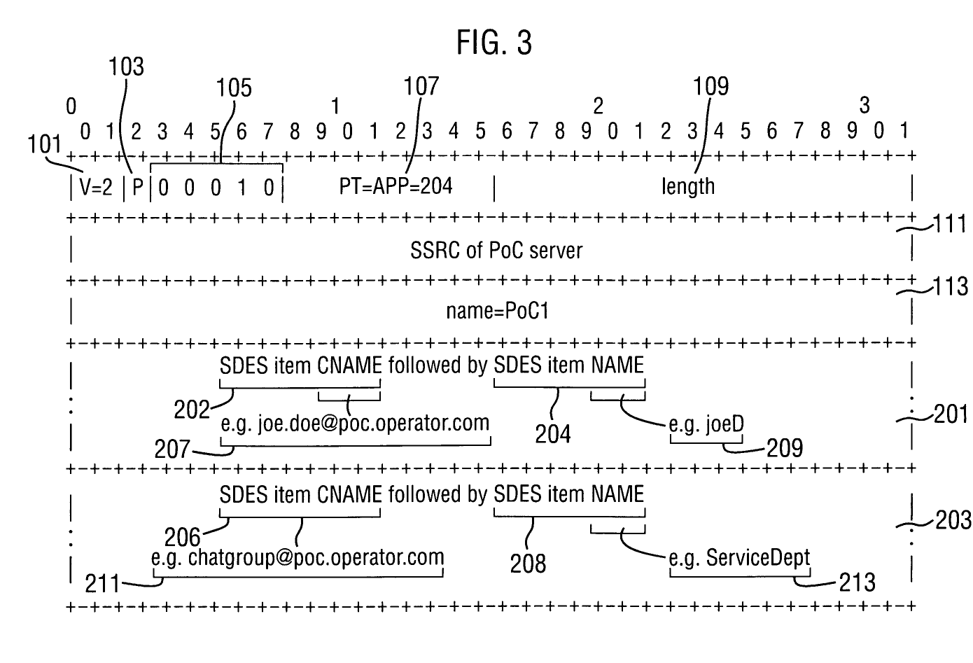

As defined in IETF RFC 3550 section 6.5 the version indicator 101 indicates the version of the RTP being used, in this example version 2. The padding bit 103 indicates if the packet contains one or more padding octets. The source count is used to identify a subtype that defines which of the various RTCP packets the present one is. In the example shown in FIG. 3 the value of 00010 indicates that this is a ‘floor taken’ RTCP packet. The payload type (PT) 107 defines the format of the RTCP payload, in the example shown the payload type is equal to APP or 204. The length indicator (length) 109 describes the length of the packet in 32 bit words, not counting the first word.

The second line of the datagram comprises a synchronisation source identifier (SSRC) 111, which identifies the synchronisation source for the originator of the packet. In the example shown where the packet is a ‘floor taken’ packet the SSRC 111 is that for the PoC server 50.

The third line of the RTCP packet comprises the displayed address (name) 113 for the push-to-talk over cellular (PoC) server 19. In the example shown in FIG. 3 the displayed address is ‘PoC1’.

The fourth and further lines of the packet comprises an information block 115. The information block comprises two source description (SDES) items.

The first source description item 116 comprises the compound canonical name (CNAME). The compound canonical name comprises the canonical name of the user 121, followed by a separator 123, followed by the canonical name of the group 125. The canonical name of the user 121 is defined as the unique identifier assigned to the user/user equipment combination. An example of such a unique identifier would be the SIP uniform resource indicator (URI) such as that shown in FIG. 3 ‘joe.doe@poc.operator.com’. The separator 123 comprises the alphanumeric string of three plus signs ‘+++’. The canonical group name 125 is defined as the unique identifier assigned to the group. An example of such an unique identifier is a SIP URI such as the example shown in FIG. 3 ‘chatgroup@poc.operator.com’.

The second source description item 118 comprises the compound display name (NAME). The compound display name comprises the display name of the user 127, followed by a separator 129, followed by the display name of the group 131. The display name of the user 127 is identifier displayed by the user equipment indicating the user/user equipment combination. An example of such an identifier would be the alphanumeric string such as that shown in FIG. 3 ‘joeD’. The separator 129 comprises the alphanumeric string of three plus signs ‘+++’. The display group name 125 is the identifier capable of being displayed by the user identifying the group. An example of such an identifier is alphanumeric string such as the example shown in FIG. 3 ‘ServiceDept’.

The information transferred within the RTCP packet can be used displayed to the user and the group information (i.e. URI and display name) may be stored in the user equipment. Storing the URI of group allows the user equipment to subscribe to participation information using the received URI of the group. For instance the mobile user equipment may send a SIP SUBSCRIBE request to the PoC Server. The received URI of the group will be placed in the Request-URI field of the SUBSCRIBE request. The mechanism defined in draft-ietf-sipping-conference-package-03, available at http://www.spinics.net/lists/ietf-ann/msg14421.html, could be used for the subscription. Additionally, the user equipment can use the received URI of the group for rejoining the group if the user drops out from the group. For example where the user equipment suffers from a temporary power failure such as during a battery replacement procedure, the user equipment on power up uses the stored group information from the floor taken RTCP message to rejoin the group.

With respect to FIG. 3 a second embodiment of the invention is shown. A ‘floor taken’ datagram is shown comprising similar elements equivalent to those shown within FIG. 3 for elements marked with the same labels. The main difference between the first and second embodiments lies in the organisation of the information block. The information block in the second embodiment of the present invention comprises two separate source description blocks 201 and 203.

The first source description block 201 comprises the canonical user name source description item (CNAME) 202 followed by the display user name source description item (NAME) 204. Using the same example as shown in FIG. 3 the user canonical name (CNAME) 202 is represented by the SIP address joe.doe@poc.operator.com 207, and the user display name (NAME) 204 is represented by the display name joeD 209.

The second source description block 203 comprises the canonical group name description item (CNAME) 206 followed by the display group name source description item (NAME) 208. Once again using the same example as used in the previous embodiment shown in FIG. 3, the canonical group name (CNAME) is chatgroup@poc.operator.com 211, and the display group name (NAME) is ServiceDept 213.

Thus the second embodiment of the present invention allows the user to receive the group information without requiring knowledge of how to read the compound canonical and display names, instead only requiring the user equipment to be able to interpret the two information block elements.

In other embodiments of the present invention the order of the two information block elements 201, 203 may be reversed to enable group information block element 203 to come before the user information block element 201 in the datagram.

In further embodiments of the present invention the group information or packet or element is piggybacked with the known floor taken packet. In such an embodiment a first ‘floor taken’ RTCP packet comprising source description information comprising canonical user name and display user name is concatenated with a second packet containing source description information comprising canonical group name and display group name to form a compound RTCP packet.

This once again enables the user equipment to subscribe to participation information and rejoin the group after disconnection.

In a further embodiment of the present invention a ‘floor taken’ RTCP packet as known in the art is followed directly by a second RTCP packet containing group information. This second packet is a predefined real time control protocol (RTCP) application (APP) packet. Once again the transmission of the group information in the form of the following separate packet can be used by the user equipment to subscribe to participation information and rejoin the group after disconnection.

Furthermore other embodiments of the present invention other types of source description (SDES) items may be further concatenated to include group information similar to that shown in the first embodiment of the invention described above. These other types of source descriptions can include source description items such as EMAIL, PHONE, LOC, TOOL, NOTE or PRIV as defined within RFC3550 sections 6.5.3 to 6.5.8 and known in the art.

Furthermore in the embodiment where the group identity and or display name of the group are transported with the source description item PRIV produces a PoC specific private extension transporting the group identity and the display name of the group.

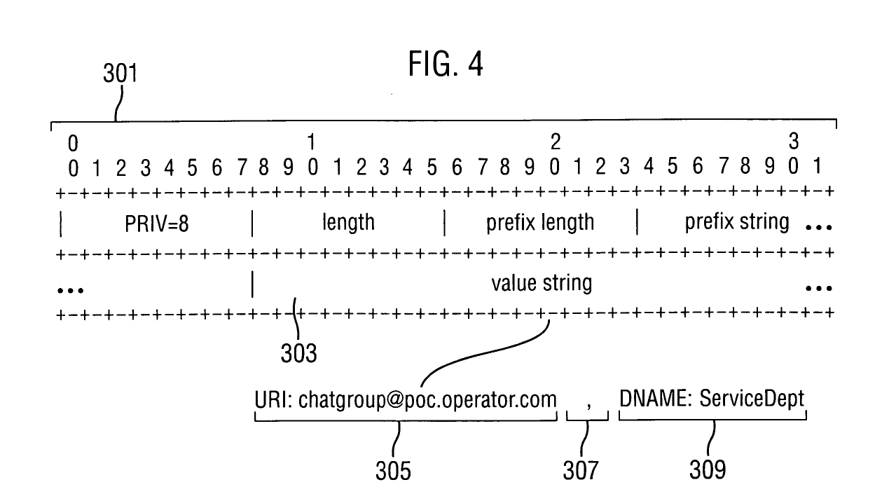

With reference to FIG. 4 a private extension source description item 301 is shown where the group information is included as a value string 303. The value string 303 in a first example comprises the two parameters of the group canonical name 305 and the group display name 309 separated with a separation string 307. In the example shown in FIG. 4 the separation string is the ascii character ‘,’ (comma), and the group canonical and display names 305, 307 are both prefixed by a string containing an identifier of the name of the parameter (e.g. ‘URI’ and ‘DNAME’). An example of the value string 303 is
URI: chatgroup@poc.operator.com, DNAME: ServiceDept

A second example of the value string 303 includes a prefix for the group canonical name (Groupinfo:) followed by the group canonical name (chatgroup@poc.operator.com) followed by a separator string (a ‘;’ semicolon) followed by the display name of the group (ServiceDept)
Groupinfo: chatgroup@poc.operator.com; ServiceDept

A third example of the value string 303 contains the group canonical name (chatgroup@poc.operator.com) and display name of the group (ServiceDept) separated with a separation string (for instance comma ‘,’).
chatgroup@poc.operator.com, ServiceDept

In further embodiments of the present invention the group canonical name is not prefixed by a identifier string. Furthermore in other embodiments of the present invention the separator string can be any string of characters used by the system designer or system user. In other embodiments of the present invention the value string comprises the group canonical name without a group display name.

In further embodiments of the present invention the canonical name of the user can be the Tel URL/URI of the user. The Tel URL/URI is the SIP equivalent to the telephone number of the user equipment as used in the public switched telephone network (PSTN).

In further embodiments of the present invention the canonical name of the group can be the Tel URL/URI of the group. The Tel URL/URI is the SIP equivalent to the telephone number of the group as used in the public switched telephone network (PSTN).

In embodiments of the invention the separators 123 and 129 can be any agreed alphanumeric text string.

Embodiments of the present invention may use other types of floor control messages or indeed other types of messages to provide the described information.

1. A communication system, comprising:
a group of user equipment in communication over a shared floor; and
a server for managing the shared floor,
wherein at least one of said group of user equipment is provided with information from the server identifying said group when the server sends a floor control message.

2. The system as claimed in claim 1, wherein said information comprises at least one of a Uniform Resource Identifier (URI) of the group and a display name of the group.

3. The system as claimed in claim 1, wherein one of said group is arranged to initiate a connection with at least one other of said group via said server using a protocol.

4. The communications system as claimed in claim 3, wherein said protocol comprises a session initiation protocol (SIP).

5. The system as claimed in claim 1, wherein one of said group of user equipment is arranged to communicate with a second user equipment via said server using a protocol.

6. The communications system as claimed in claims 5, wherein said protocol comprises a real time control protocol (RTCP).

7. The system as claimed in claim 6, wherein said at least one of said group of user equipment provided with said information is arranged to receive said information in a message using said protocol.

8. The system as claimed in claim 1, wherein said at least one of said group of user equipment is arranged to use said information to subscribe to group participation information or rejoin said group.

9. The communications system as claimed in claim 1, wherein said information is provided to said at least one of said group in a real time control protocol (RTCP) message.

10. The communications system as claimed in claim 1, wherein said communications system comprises a push-to-talk over cellular communications system.

11. The communications system as claimed in claim 1, wherein said information is provided to said at least one of said group in said floor control message.

12. The communications system as claimed in claim 11, wherein said information includes information about which user equipment has taken the shared floor for communicating with other user equipment of the group.

13. The communications system as claimed in claim 11, wherein said floor control message comprises a ‘floor taken’ message.

14. The communications system as claimed in claim 13, wherein said information is stored within said ‘floor taken’ message as at least part of a source description item.

15. The communications system as claimed in claim 1, wherein said information is provided in a message concatenated with information identifying at least one user.

16. The communications system as claimed in claim 1, wherein said information is provided in a field of a message containing a plurality of fields.

17. The communications system as claimed in claim 16, wherein said field comprises at least one of said information and said information along with further information.

18. The communications system as claimed in claim 1, wherein said server comprises a push-to-talk over cellular (PoC) server.

19. A server arranged to operate in a communications system, said communications system comprising:
a group of user equipment in communication over a shared floor, wherein said server is arranged to manage the shared floor and is further arranged to transmit to at least one of said group of user equipment information identifying said group when the server sends a floor control message.

20. User equipment arranged to operate in a communications system over a shared floor, said communications system comprising:
a server arranged to manage the shared floor, wherein said user equipment is arranged to receive from said server information identifying a group when the server sends a floor control message.

21. A method of communication, within a communications system comprising a group of user equipment in communication over a shared floor and a server arranged to manage the shared floor, said method comprising the steps of:
transmitting from said server to at least one of said group of user equipment information identifying said group when the server sends a floor control message; and
receiving said information at said at least one of said group of user equipment.

22. A communication system, comprising:
a group of communication means for communicating over a shared floor; and
managing means for managing the shared floor,
wherein at least one of said group of communication means is provided with information from the managing means identifying said group when the managing means sends a floor control message.
